(19) United States
(12) Patent Application Publication
(10) Pub. No.: US 2013/0236852 A1
(43) Pub. Date: Sep. 12, 2013

(54) UNIVERSAL DENTAL IMPLANT STRUCTURE

(71) Applicant: Yen-Chang LIN, Nantou County (TW)

(72) Inventor: Yen-Chang LIN, Nantou County (TW)

(21) Appl. No.: 13/413,488

(22) Filed: Mar. 6, 2012

(51) Int. Cl. A61C 8/00

(52) U.S. Cl. 433/173

(57) ABSTRACT

A universal dental implant structure includes an implant member and a tooth cap. The implant member has an implant portion, an extended holding portion connecting to the implant portion and a coupling cavity located at one side of the extended holding portion remote from the implant portion. The implant portion is anchored in a cancellous bone and a cortical bone. The extended holding portion is extended outside the cortical bone in a range between 3 mm and 6 mm. The tooth cap has a coupling portion to couple on and fasten to the extended holding portion. The dental implant structure of the invention resolves the problem of occlusion interference in the conventional one-piece type dental implant structure and provides the advantage of withstanding high shearing force thereof, and also has the advantage of flexible assembly in the two-piece type dental implant structure through an abutment.

### FIELD OF THE INVENTION

The present invention relates to a dental implant structure and particularly to a universal dental implant structure.

### BACKGROUND OF THE INVENTION

The technology of dental implant is well developed now. Dental implant is performed first by implanting an implant made of titanium that has high bio-compatibility into an alveolus for positioning. After few months when the implant has been firmly fastened to the bone in the alveolus, a denture is mounted. As the implant is directly connected to the bone, a desired support force can be provided for chewing harder foods. Thus it is widely accepted. The conventional dental implant includes an implant member which can be categorized into a one-piece type and a multi-piece type. The one-piece type implant member, such as U.S. publication No. 2010/0119993 entitled “Dental implant” is to directly implant the one-piece type implant member into the cancellous bone and cortical bone of the gum. After few months when the one-piece type implant member is integrated and fastened to the cancellous bone and cortical bone, a tooth cap is molded and mounted onto the one-piece type implant member. Such a method has the advantage of less restriction on the implant depth, and the implant member is sturdier and less likely to be fractured. But it also has a drawback, i.e., as the one-piece type implant member is extended outside the cortical bone about 10 mm, occlusion interference easily takes place when chewing of the patient during the bone integration period. This could result in strength deficiency of the bone integration and affect the sturdiness after implantation, and the bone could be atrophied to result in implantation failure. Moreover, the one-piece type implant member cannot be coupled with other tooth cap, the design space and types of the denture also are limited.

The multi-piece type implant member, such as U.S. publication No. 2007/0254265 entitled “Dental implant” includes an implant member, an abutment and a crown. During implantation process, the implant member is implanted first in the cancellous bone and cortical bone of the gum without jutting outside the cortical bone. As the cortical bone is covered by a layer of soft tissue and the oral cavity is located right above the soft tissue, no occlusion interference occurs after the implant member is implanted. Once the implant member and the cancellous bone and cortical bone are integrated and fastened, the soft tissue is then incised via surgery and the abutment is fastened to the implant member for positioning; finally, the crown is molded and mounted onto the abutment jutting outside the soft tissue. Such an approach has the advantage of eliminating the occlusion interference and making diversified designs of the crown possible to mate different types of tooth caps; however, it also has a drawback, i.e. the implant member must be precisely fastened and leveled on the cortical bone to facilitate coupling of the crown in the later process. As uncertainty still cannot be totally eliminated in medical clinics, if the implant member is implanted too deep into the cortical bone, it will be slightly covered by the cortical bone during bone integration period to result in difficulty of coupling with the crown in the later process. Another drawback is having weaker structural strength. Since the crown is mostly fastened to the implant member by screwing and positioned in the soft tissue, its horizontal bracing force also is insufficient. Thus when the crown is subject to a horizontal shearing force, the screw fastening structure could be easily fractured. In the event that such an incident happens, the residual screw fastener still remains in the implant member to cause removing and repair difficult. To resolve the aforesaid issues, the implant member and the abutment in this prior art are coupled together to form an abutment joint, and the crown is coupled on the abutment joint, thereby can withstand a greater horizontal shearing force to avert transverse fracturing.

As the one-piece type implant member is extended outside the cortical bone about 10 mm after implantation, and two-piece type implant member is also extended outside the cortical bone about 10 mm after mounting the abutment, in the event that the occlusion space between the upper and lower teeth of a patient is smaller, either of the implant member of the one-piece type or abutment of the two-piece type has to be ground for a selected height to meet actual requirement. It is troublesome in use. Moreover, a dentist has to prepare one-piece implant structure and two-piece implant structure to meet requirements of different patients, and they cannot be interchanged. Thus usability is lower, and the costs also are higher.

Please refer to FIGS. 1A and 1B, when the conventional dental implant is performed, as the gum 1 could be uneven to cause tilt or bump, when an implant member 2 of a two-piece dental implant structure is implanted into the gum 1, the implant member 2 could be exposed outside the gum 1 to result in undesired appearance as shown in FIG. 1A. Moreover, because the implant member 2 has multiple screw threads formed on the surface thereof, the exposed screw threads could breed microbes and cause ailments. To prevent exposure of the screw threads, additional fabrication processes are needed that are time-consuming and costly. Also referring to FIG. 1B, if the implant member 2 is implanted too depth into the gum 1, mounting of the abutment in the later process could be difficult. There is still room for improvement.

### SUMMARY OF THE INVENTION

The primary object of the present invention is to provide a universal dental implant structure adaptable to both one-piece type and two-piece type dental implants.

Another object of the invention is to solve the problem of the conventional dental implant structure that requires extra grinding process for inadequate occlusion space and is time-consuming and effort-wasting.

Yet another object of the invention is to overcome the problem of the conventional dental implant structure that is easily fractured caused by the horizontal shearing force.

To achieve the foregoing objects, the present invention provides a universal dental implant structure that is implanted and positioned on a patient's gum. The gum has a cancellous bone, a cortical bone located on the surface of the cancellous bone and a soft tissue located at one side of the cortical bone remote from the cancellous bone. The universal dental implant structure includes an implant member and a tooth cap. The implant member has an implant portion, an extended holding portion connecting to the implant portion and a coupling cavity located on one side of the extended holding portion remote from the implant portion. The coupling cavity is extended from the extended holding portion towards the implant portion and has an internal thread section on an inner surface thereof. The implant portion is anchored in the cancellous bone and cortical bone. The extended holding portion is extended outside the cortical bone in a range between 3 mm and 6 mm. The tooth cap has a coupling portion to couple on and fasten to the extended holding portion for positioning.

The structure thus formed provides features as follow:

1. With the extended holding portion extended outside the cortical bone between merely 3 mm and 6 mm the problem of occlusion interference during bone integration can be averted and inadequate bone integration strength can be prevented.

2. Compared with the conventional technique of extending the implant member outside the cortical bone about at least 10 mm, the invention extends the implant member by 3 mm to 6 mm, thus is avoided performing the grinding adjustment caused by inadequate occlusion space between the upper teeth and lower teeth and the problems of time-consuming and effort-wasting.

3. In the event that the occlusion space is insufficient, the tooth cap and implant member can be coupled to get the advantage of the one-piece dental implant structure. On the other hand, when the occlusion space is greater, an abutment can be used to fasten to the coupling cavity of the implant member to achieve the advantage of the two-piece dental implant structure with the flexibility of changing shape and size of the abutment. Thereby it is adaptable to one-piece type and two-piece type structure.

4. The dentist requires preparing merely the implant member with the same specification to meet the requirements of different patients, thus usability improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of a conventional dental implant on an uneven gum.

FIG. 1B is another schematic view of a conventional dental implant on an uneven gum.

FIG. 2 is an exploded view of a first embodiment of the invention.

FIG. 3 is a schematic view of the invention showing a teeth occlusion space.

FIG. 4A is a schematic view of the first embodiment showing positioning of the implant member.

FIG. 4B is a schematic view of the first embodiment showing positioning of the tooth cap.

FIG. 5 is a schematic view of a second embodiment showing positioning of the tooth cap.

FIG. 6 is an exploded view of a third embodiment of the invention.

FIG. 7 is an exploded view of a fourth embodiment of the invention.

FIG. 8A is a schematic view of the fourth embodiment of the invention showing positioning of the implant member.

FIG. 8B is a schematic view of the fourth embodiment of the invention showing positioning of the abutment.

FIG. 8C is a schematic view of the fourth embodiment of the invention showing positioning of the tooth cap.

FIG. 9 is a schematic view of a fifth embodiment of the invention showing positioning of the implant member in the gum.

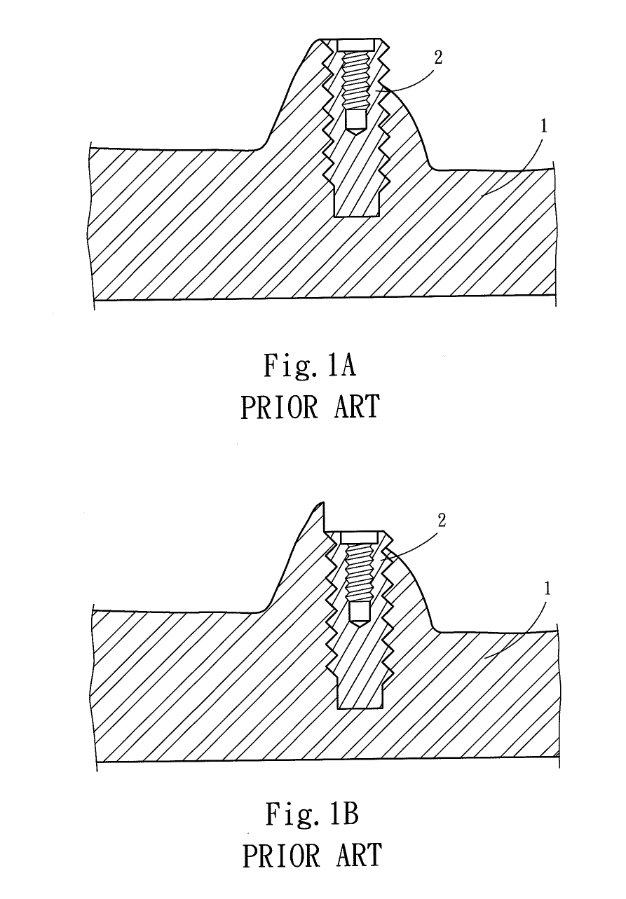

### DETAILED DESCRIPTION OF THE PREFERRED EMBODIMENTS

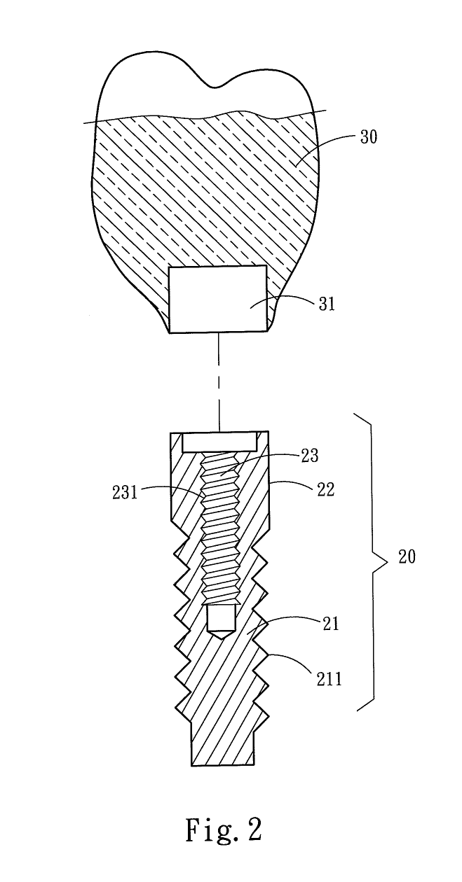

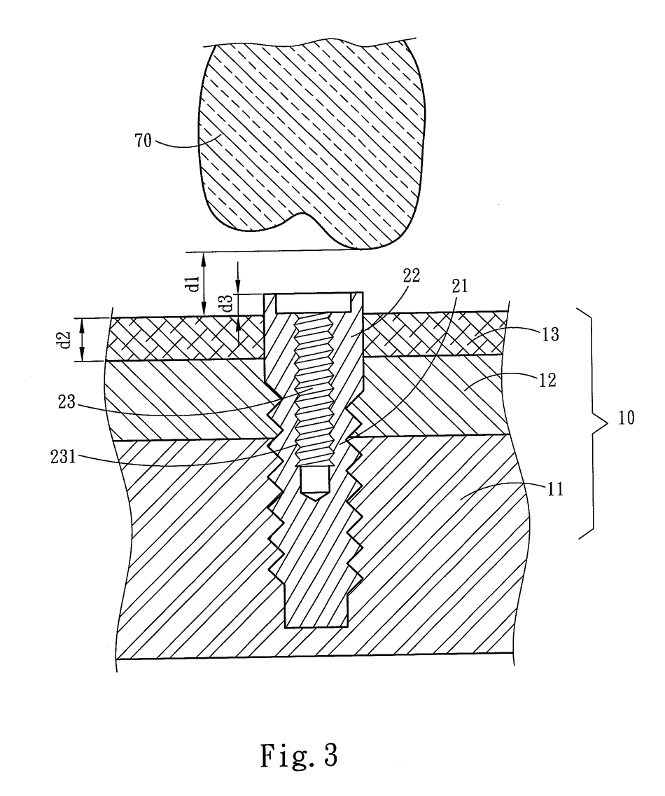

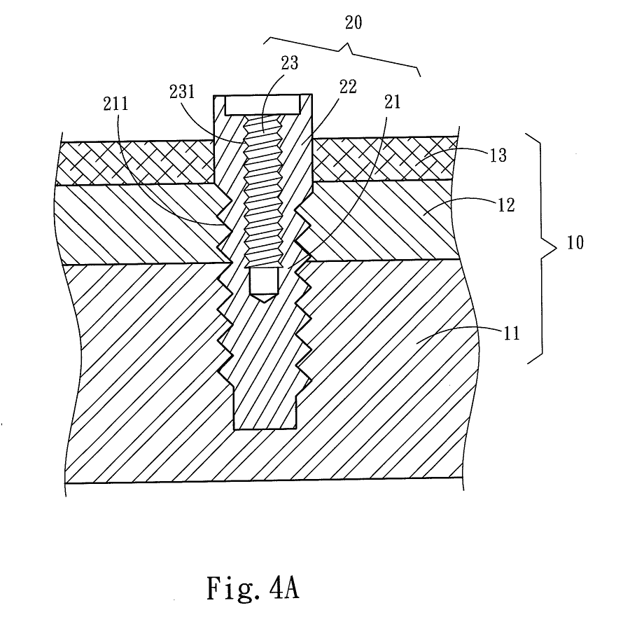

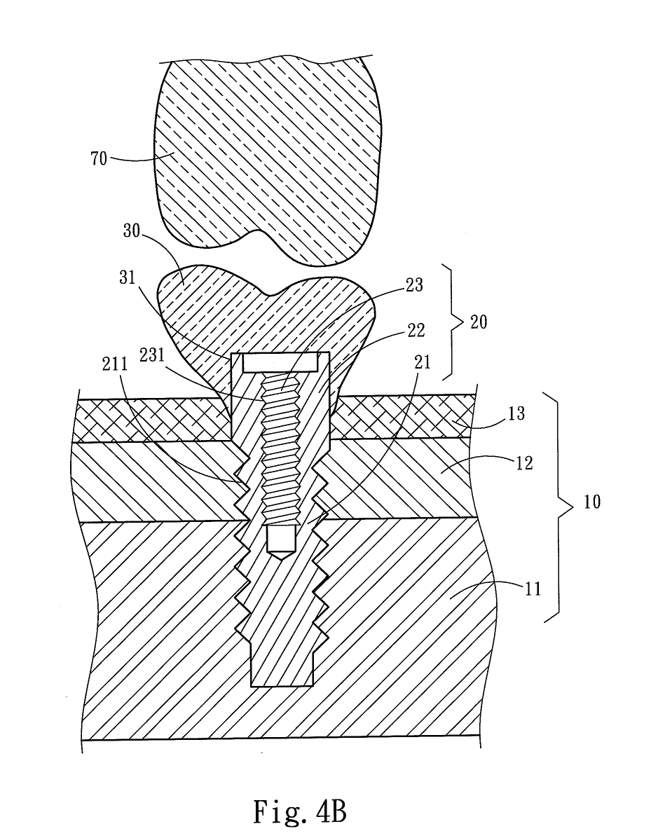

Please refer to FIGS. 2 and 4A, the present invention aims to provide a universal dental implant structure implanted in a patient's gum 10. The gum 10 has a cancellous bone 11, a cortical bone 12 located on the surface of the cancellous bone 11 and a soft tissue 13 located at one side of the cortical bone 12 remote from the cancellous bone 11. The universal dental implant structure includes an implant member 20 and a tooth cap 30. The implant member 20 has an implant portion 21, an extended holding portion 22 connecting to the implant portion 21 and a coupling cavity 23 located on one side of the extended holding portion 22 remote from the implant portion 21. The coupling cavity 23 is extended from the extended holding portion 22 towards the implant portion 21 and has an internal thread section 231 on an inner surface thereof. The tooth cap 30 has a coupling portion 31 to encase and fasten to the extended holding portion 22.

In the event that the dental implant is done on a lower tooth and a small occlusion space is formed between the upper tooth and lower tooth, referring to FIG. 3, if the upper tooth 70 and the lower soft tissue 13 are spaced from each other at a distance d1 of merely 5 mm, a one-piece dental implant structure as previously discussed can be chosen. As the extended holding portion 22 is extended merely outside the cortical bone 12 in a range between 3 mm and 6 mm, the length of the extended holding portion 22 can be selected according to the soft tissue 13 and the occlusion space between the upper and lower teeth of the patient. For instance, assumed that the soft tissue 13 has a thickness d2 of 2 mm, the length d3 of the extended holding portion 22 extended outside the soft tissue 13 can be 1 mm to 4 mm so that there is still sufficient room for mounting the tooth cap 30 without a great deal of extra fabrication.

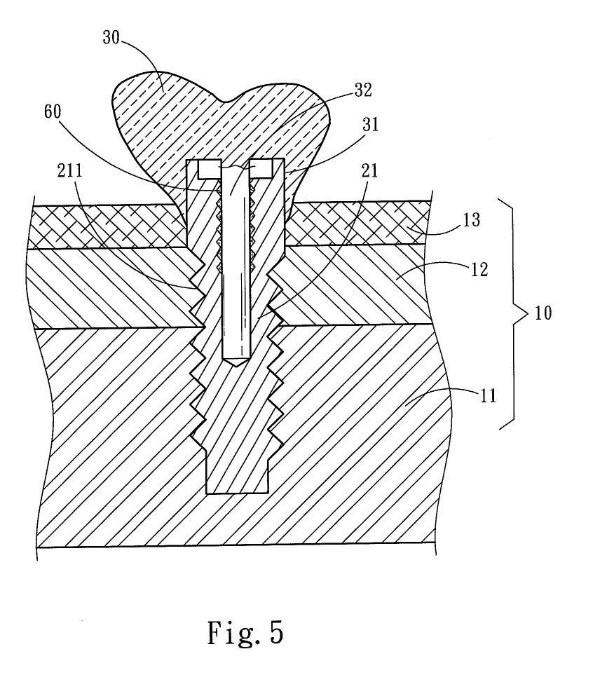

Also referring to FIG. 4A, the implant portion 21 is anchored in the cancellous bone 11 and cortical bone 12, and the extended holding portion 22 is extended outside the cortical bone 12 in a range between 3 mm and 6 mm and partly covered by the soft tissue 13. The soft tissue 13 is formed at a thickness about 1 mm to 2 mm, depending on the patient. After the implant portion 21 has been anchored in the cancellous bone 11 and cortical bone 12, a bone integration period is required. When this period is elapsed, referring to FIG. 4B, the tooth cap 30 is coupled on the implant member 20. Referring to FIG. 5, in order to reinforce coupling between the tooth cap 30 and implant member 20, the tooth cap 30 further has an auxiliary holding portion 32 inserted into the coupling cavity 23 so that contact area between the tooth cap 30 and implant member 20 increases. The auxiliary holding portion 32 also can enhance the strength of the tooth cap 30 to withstand the horizontal shearing force. Furthermore, the gap between the auxiliary holding portion 32 and coupling cavity 23 is filled with adhesive 60 to form secure bonding. While the implant member 20 of the conventional technique includes merely the implant portion 21, the length of the coupling cavity 23 is controlled via the length of the implant portion 21. However, in the invention, as the coupling cavity 23 covers a greater range that includes the implant portion 21 and extended holding portion 22, it has a greater length to increase the depth for coupling, thus more contact area is provided to improve coupling between them.

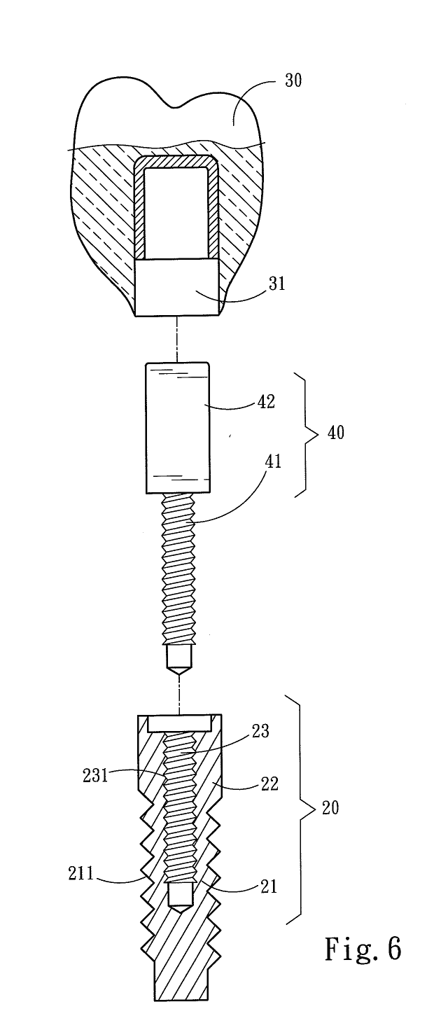

In the event that sufficient occlusion space is provided, after the implant member 20 is embedded, the two-piece dental implant structure can be selected to get more choices of the tooth cap 30. Referring to FIG. 6, the invention can also provide an abutment 40 fastened to the implant member 20. The abutment 40 has a fastening portion 41 fastened to the coupling cavity 23 and a holding portion 42 outside the coupling cavity 23 connected to the fastening portion 41. The tooth cap 30 has a housing space that mates the shape of the holding portion 42 to hold the holding portion 42 so that the tooth cap 30 couples on the abutment 40 and fastens to the extended holding portion 22 via the coupling portion 31, thereby after the implant member 20 is embedded, various types of the abutment 40 and tooth cap 30 can be selected for mating. It is to be noted that the tooth cap 30 fully covers the holding portion 42 and anchors on the extended holding portion 22, hence can withstand greater horizontal shearing force.

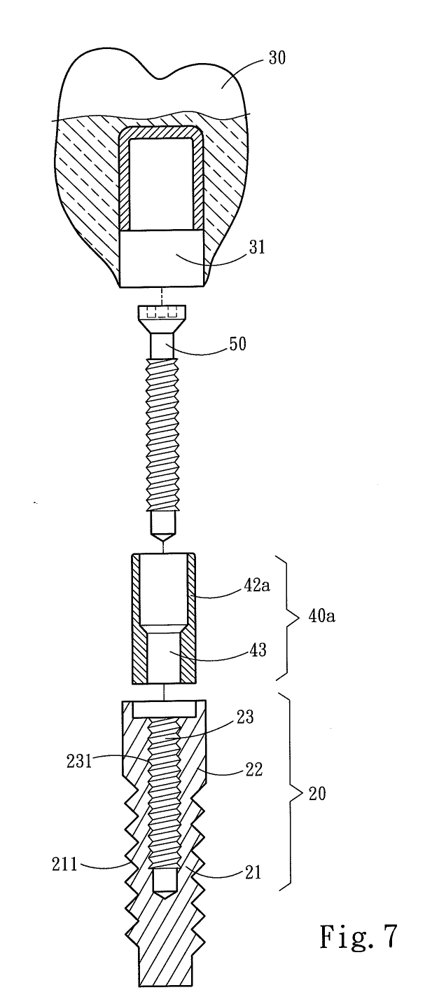

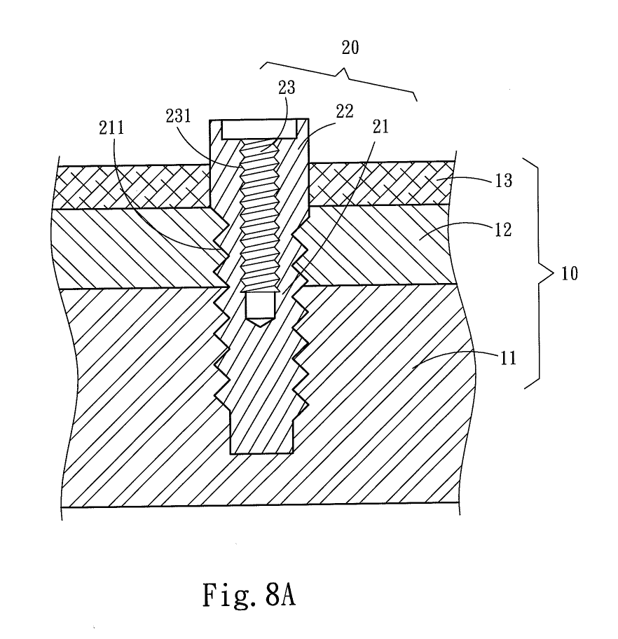

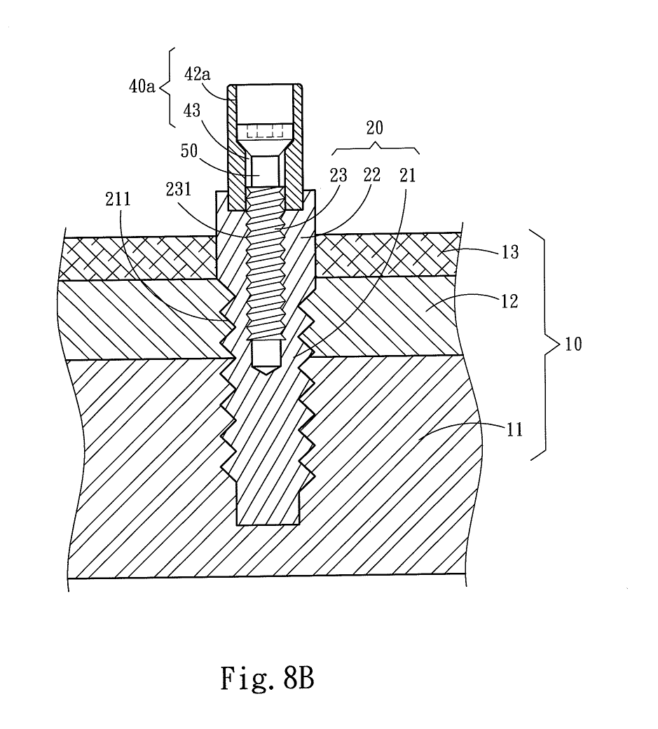

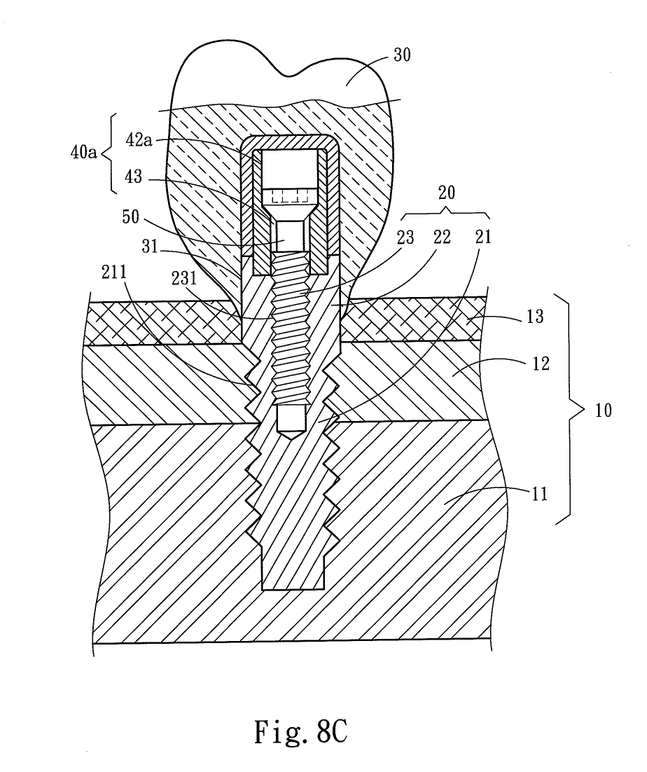

Please refer to FIG. 7 for another type of structure of the abutment 40a. It has a holding portion 42a and a fastening hole 43 running through the holding portion 42a. The fastening hole 43 is run through by a screw fastener 50 to fasten to the coupling cavity 23, thereby is coupled the implant member 20 and the abutment 40a together. The tooth cap 30 has a housing space mating the shape of the holding portion 42a to hold the holding portion 42a. The tooth cap 30 encases the abutment 40a and fastens to the extended holding portion 22 via the coupling portion 31. Also referring to FIG. 8A, implantation of the implant member 20 is the same as that of the one-piece type, by implanting the implant portion 21 in the cancellous bone 11 and cortical bone 12, with the extended holding portion 22 formed on the soft tissue 13 and extended outside the cortical bone 12 by 3 mm to 6 mm. The implant portion 21 has an external thread section 211 on the outer surface thereof to fasten to the cortical bone 12 and cancellous bone 11 by screwing.

Referring to FIG. 8B, after the bone integration has been finished, the abutment 40a is fastened to the implant member 20. In this embodiment, the fastening hole 43 is run through by the screw fastener 50 to fasten to the coupling cavity 23 so that the abutment 40a is positioned on the implant member 20. It is to be noted that the extended holding portion 22 of the implant member 20 is a recess located on one side remote from the implant portion 21 to facilitate fastening of the abutment 40a and also increase the structural strength of the abutment 40a in the horizontal direction.

Referring to FIG. 8C, after the abutment 40a is fastened, the tooth cap 30 can be made by mating the tooth location via the holding portion 42a through molding. The tooth cap 30 can fully encase the abutment 40a by bonding via adhesive. By fastening the coupling portion 31 to the extended holding portion 22 a firmer holding effect can be accomplished.

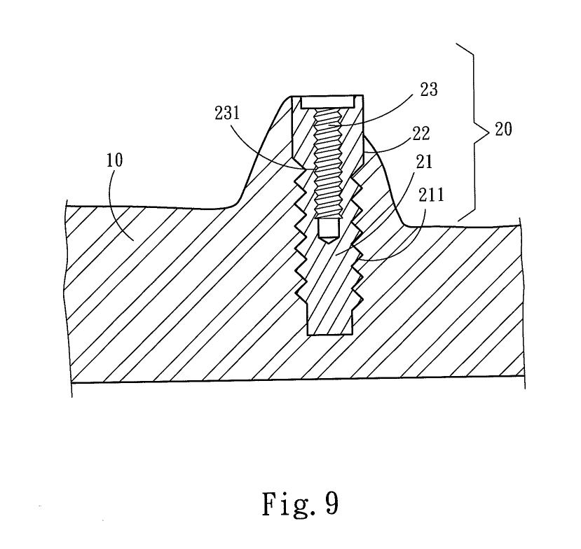

Referring to FIG. 9, in the event that the gum 10 is tilted or bulged, the extended holding portion 22 can prevent the thread section 211 of the implant portion 21 from exposing, thus is avoided the problem of microbe infection and ailments. Such an approach can also prevent the implant member 20 from implanting too deep into the gum 10, hence is avoided difficulty in the later treatment.

It also to be noted that the extended holding portion 22 can also serve as a buffer for screw fastening. In the event that the implant portion 21 is embedded too deep into the cortical bone 12, the extended holding portion 22 is still extended between the cortical bone 12 and soft tissue 13, therefore is avoided the problem to couple with the abutment 40 or 40a in the later process. In addition, through the extended holding portion 22, an allowance is provided for mounting the tooth cap 30, thereby is avoided the undesired appealing problem caused by exposing the implant portion 21 outside the gum 10 due to the uneven gum 10, or installation difficulty caused by implanting the implant portion 21 too deep into the gum 10.

As a conclusion, compared with the conventional techniques, the present invention provides features as follow:

1. By extending the extended holding portion outside the cortical bone by merely 3 mm to 6 mm, the problem of inadequate bone integration strength caused by occlusion interference during bone integration period can be prevented.

2. Compared with the conventional techniques that the implant member is extended outside the cortical bone by at least 10 mm, the invention extends the implant member by 3 mm to 6 mm, hence is avoided performing grinding adjustment caused by inadequate occlusion space between the upper tooth and lower tooth and the problems of time-consuming and effort-wasting.

3. The tooth cap and implant member can be coupled for use when the occlusion space is inadequate, thus provides the advantage of one-piece type dental implant structure. When the occlusion space is greater, the abutment can be provided to fasten to the coupling cavity of the implant member, thus offers the advantage of the two-piece type dental implant structure with the flexibility of changing the shape and size of the abutment. As a result, the features of the one-piece type and two-piece type dental implant structures are both available in the invention.

4. Dentists require preparing merely the dental implant structure with the same specification to meet the requirements of different patients, thus usability improves

5. By providing the auxiliary holding portion to couple the tooth cap with the coupling cavity, the contact area between the tooth cap and the implant member increases, hence the holding strength between them also is enhanced. This solves the problem that when the occlusion space between the upper and lower teeth is smaller, since the implant member is extended outside the cortical bone in a shorter length, the coupling strength between the tooth cap and the implant member is inadequate to result in loosening of the implant member from the tooth cap.

6. Through the extended holding portion, the coupling cavity can be formed deeper to provide firmer coupling.

7. Even the invention is used on an uneven gum, through the buffer of the extended holding portion, the external thread section of the implant portion would not be exposed to cause implant difficulty or aliments.

While the preferred embodiments of the invention have been set forth for the purpose of disclosure, they are not the limitations of the invention, and modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A universal dental implant structure implanted in a gum which includes a cancellous bone, a cortical bone located on a surface of the cancellous bone and a soft tissue located on one side of the cortical bone remote from the cancellous bone, comprising:
an implant member including an implant portion, an extended holding portion connecting to the implant portion and a coupling cavity located at one side of the extended holding portion remote from the implant portion, the coupling cavity being extended from the extended holding portion towards the implant portion and including an internal thread section on the surface thereof, the implant portion being anchored in the cancellous bone and the cortical bone, the extended holding portion being extended outside the cortical bone in a range between 3 mm and 6 mm; and
a tooth cap including a coupling portion to couple on the extended holding portion for positioning.

2. The universal dental implant structure of claim 1, wherein the tooth cap further includes an auxiliary holding portion extended into the coupling cavity.

3. The universal dental implant structure of claim 1 further including an abutment which is fastened to the implant member and includes a fastening portion fastened to the coupling cavity and a holding portion connecting to the fastening portion outside the coupling cavity, the tooth cap including a housing space that mates the shape of the holding portion for holding thereof so that the tooth cap couples on the abutment and fastens to the extended holding portion via the coupling portion.

4. The universal dental implant structure of claim 1 further including an abutment located at one side of the implant member remote from the implant portion and a screw fastener, the abutment including a holding portion and a fastening hole running through the holding portion, the screw fastener fastening to the coupling cavity through the fastening hole to fasten the implant member and the abutment together, the tooth cap including a housing space that mates the shape of the holding portion for holding thereof so that the tooth cap couples on the abutment and fastens to the extended holding portion via the coupling portion.
